(19) United States
(12) Patent Application Publication
(10) Pub. No.: US 2003/0141411 A1
(43) Pub. Date: Jul. 31, 2003

(54) Novel method to secure airline travel

(76) Inventors: Ashish Pandya, El Dorado Hills, CA (US); Alpa Pandya, El Dorado Hills, CA (US)

Correspondence Address: GARY CARY WARE & FREIDENRICH LLP, 1755 EMBARCADERO ROAD, PALO ALTO, CA, 94303-3340, US

(21) Appl. No.: 10/122,014

(22) Filed: Apr. 12, 2002

Related U.S. Application Data
(60) Provisional application No. 60/353,527, filed on Jan. 31, 2002.

(51) Int. Cl. B64F 1/00

(52) U.S. Cl. 244/114 R; 52/174; 209/2

(57) ABSTRACT

Our invention is a secure air travel system and method that eliminates security risks associated with passenger baggage by not allowing checked baggage and most carry-on baggage on the airliners that carry passengers. This method creates a two separate classes of air carriers or two classes of air carrier flights. One class transports passengers only and the other class transports only luggage of passengers between various locations. By eliminating the checked bags and most carry-on bags on the passenger-only flights, the security risks from weapons, bombs or other hazardous materials on these bags are totally eliminated from passenger-only flights. This mode of air travel can be implemented to co-exist with the current airlines and air travel methods.

### RELATED APPLICATIONS

This application claims priority, under 35 USC §120, from U.S. Provisional Patent Application No. 60/353,527, filed on Jan. 31, 2002.

### BACKGROUND OF THE INVENTION

This invention relates generally to a system and method of secure airline travel anywhere in the world and, in particular, to a secure airline travel system and method deployed across airports.

There are various security measures deployed at the airports. These measures are extremely ineffective in ensuring security of the passengers. The passengers go through metal detectors at the airport and their baggage is screened using X-ray devices to ensure that no weapons are being carried on to the airplane. However, the events of Sep. 11^{th}, 2001 clearly highlighted the ineffectiveness of these security measures. Every year there are also several incidents where airplanes explode in mid-air by bombs carried on the planes through the checked baggage. Baggage checking on the airlines is unable to detect sophisticated bombs and hazardous materials and it slips through on the airplane, causing serious risk to the safety of the travelers including passengers and flight crews.

New methods are being deployed with a great deal of inefficiency and inconvenience to the travelers including more thorough checks for the carry-on bags, shoes and checked baggage using bomb and biohazard detectors being deployed at some airports. Massive deployment of these mechanisms is costly, time consuming and difficult to sustain for extended periods of time. Thus the security risk to the air traffic still remains very high. The various current methods are just a deterrent but are not fool-proof security measures. Random matching of checked bags with a valid ticketed passenger on the flight is an example of such a new method being deployed. This method is only as successful as the probability of finding the right luggage that may carry a security risk to the flight. Its success also depends on the capability of the screening machines to detect any weapons.

### SUMMARY OF THE INVENTION

This invention is a novel system and method of secure airline travel that superior to any of the current methods of securing airline travel deployed across the airports. All the air travel security experts around the world have not been able to make the travel safe. The reason the current methods can never fully prevent bombs and weapons checked in the planes through the baggage is because of the flaws in the equipment being used for screening them or operator errors or both.

The main issue of air travel security risk comes from the checked baggage or carry-on baggage. Our invention will change the practice of carrying the luggage of the passengers in the airplane with the passengers. Everyone who travels needs to transport their bags but it does not have to fly with them. Our secure air travel method eliminates these security risks by not allowing checked baggage on the airliners that carry passengers. This method creates a two separate category of carriers. One transports passengers only and the other, which we call a companion carrier, transports luggage of travelers between various locations. These passenger companion carriers transport luggage between the corresponding passenger destinations. By eliminating the carry-on and checked bags on the passenger airlines, the security risks from weapons, bombs or other hazardous materials are totally eliminated. This mode of air travel can be implemented to co-exist with the current airlines and air travel methods.

Travelers, including passengers and crew, use the airlines to go from one location to another. By current travel procedures their baggage is checked-in or carried on with them on the airplane. The checked-in baggage is delivered to the passengers at the destination airport terminal, where they can pick-up their bags before departing from the airport. The passengers do not need or have access to their checked luggage during the travel. The passengers can use the same method of checking and receiving their baggage using our invention as in the current methods or they may avail some new and novel methods of transporting their baggage coming to fruition as our invention becomes implemented by the airlines. There can be multiple ways in which passengers will be able to check-in their baggage on to the companion carriers. This may include check-in at the airport check-in counters, luggage pick-up from home or other origin departure location. Delivery of the luggage may be made to the destination airport terminals or final destination (home, business, pleasure resort). This service may be provided by the passenger airline company that transports the passengers using luggage carriers or could be provided by other competing luggage carrier companies. Hence, the passengers are not inconvenienced by this change.

There are several economic benefits that come out of implementing this change along with making the airline travel highly secure. The passenger airliners may be able to continue to charge the same airfare or potentially higher airfare for the added benefit of providing secure and safe travel for their passengers resulting from the implementation of this secure travel method. Additionally, not carrying any checked-in bags airlines will tremendously increase the airline travel security while at the same time reducing their check-in and take off time. These changes can have substantial economic benefits to the airline industry, by eliminating the risk perception in the flying public and thereby increasing the number of travelers.

Another significant benefit of this invention is that it takes the liability of lost bags off passenger airlines and thus helps their financials. Further, since the passenger airlines will no longer be carrying or handling the baggage, they will benefit significantly from reduction in resources required for baggage handling from the check-in at the departing airport all the way through delivery on the conveyer belts at luggage pick-up at the destination airports. An entirely new industry can be created and can survive on this business model transporting the luggage of the traveling passengers.

Further, because the baggage will not be allowed on the passenger flights, the overall passenger carrier liability insurance costs would significantly go down. This would result in additional financial benefit for the airlines implementing carrying passengers only, or carrying primarily passengers only. This will allow the airlines to further increase their profit margins or use the funds saved towards more security.

The carry-on baggage will also be not allowed on the passenger airliners except for items needed for medical/health reasons, items legally allowed by law, or other pre-authorized items. Travelers using laptop/notebook computers or other accessories will be able to request those from the airlines at the time of the ticketing or at the airport. Airlines may also be equipped with commonly carried work items for frequent travelers on board. This might take the form of having an on-board document management site. Books and other material may be reserved ahead of time if necessary for the pleasure of the traveler.

The bags will be the baggage carrier's responsibility. This can be very convenient for the passengers and the airlines. For the passengers it would be a luxury to have the option for the bags to be picked up by a courier company from their point of origin or from the airport and have it delivered to their destination with minimal extra cost. The total cost to travel will not be significantly affected because the airlines would be able offer lower rates because of the reduced overhead cost. The courier companies can have their own security procedures as required by Federal Aviation Administration safety standards and requirements. They can offer express services for the passengers. Also fragile equipment like laptops can be transported using sturdy boxes.

The luggage carrier service may work with the airlines to synchronize their carrier flights with the passenger flights to coordinate the transportation of the bags for the passengers. The luggage carriers will be able to carry the luggage for flights between the same origin and destination location flights from multiple airline companies, thereby driving economies of scale and lowering the luggage transport charges. These carriers could also be on a profit sharing basis with the passenger airlines.

This model of operation for air travel would also be valid for ground travel through railroads, buses, maritime travel and space travel, making it safer and more efficient. Separating passengers from the luggage courier makes the entire mode of transportation safer, more efficient and more profitable. Following are the steps in our airline travel security system invention:

Ticketing Process

In our invention, passengers are able to use the same ticketing methods as they use today. Tickets may be reserved directly with airlines, through travel agents, online on the web, at airport terminals and by e-tickets. The process for ticketing may be changed to include the passengers requesting new services that may be offered by the airlines implementing this new security system. Passengers will select the mode of their luggage transportation either through the airline or through other luggage carriers. The passengers can also select whether the luggage will be checked-in at the airport or will it be picked up at their travel origination place (e.g. home, or hotel or business or other). Likewise the passengers will have the options to select where their luggage will be delivered either at the destination airport terminal or other destination location of their choice. The default option would be to use the airport terminal check-in and pick-up with the luggage carrier of the airline being traveled on. Airlines may offer different airfare for no luggage flights, if the passenger gets the luggage transported on their own.

The passengers will be able to request other services during flight from an option of new choices that may be offered by the airlines. These may include being able to request laptop/notebook computers, specific magazines or books or baby supplies or any other service as may be offered by the airlines as a result of the new security system implementation.

Seat Assignment

An alternative to the current seating assignment methods may be implemented to provide further security. The passengers may be able to request window or aisle seats or groups of seats as they wish but will not get a specific seat assignment until some time before the flight departure. This substantially random seat assignment and late seat assignments would increase security significantly by not allowing accomplices of terrorists or hijackers from hiding weapons inside the pre-assigned seats on specific flights. This can improve the security of the flights from insider support. This may or may not be an issue and is an additional security measure, but is not required to implement the overall security system presented in this patent.

Passenger Check-in Process

When this new security system is implemented, the check-in process may involve steps like separate baggage check-in and passenger check-in. Passengers will go through airport security checks like metal detectors or any other checks instituted from time to time as per air travel security regulations. Passengers will not be allowed to carry any baggage onto the airlines. Exceptions to this may include medical/health related equipment if certified by a competent doctor or medical professional. This will be allowed if the airlines do not provide those services, where a specific medical device may be offered by the airline during the travel. Other exceptions may be those allowed by the airline safety regulations that are created at those times. The passengers needing any exceptions will be required to indicate these needs ahead of time, and will go through a special screening process, which will not slow down the regular secure travel. They may be required to allocate more time for security checks unlike the other passengers using our secure system.

Baggage Check-in Process

Luggage of the passengers will be transported on separate baggage carriers and not on the passenger flights. The passengers will have an option to choose the luggage carriers. The luggage carriers may be different than the airline on which the passenger travels. The passengers will be able to check-in their baggage at the airport terminal or curb-side check-in the same way as done currently, however the bags and luggage will be transported on to the luggage carrier instead of the passenger airline. Passengers will be given an appropriate tracking numbers to be able to match the luggage for pick-up at their destination and use it to track baggage in case of lost baggage.

Baggage Transportation and Screening

Checked-in luggage will be screened and transported to their destinations by the airline or the baggage transportation company, as the case may be, on special luggage carrier aircraft. The baggage handling company will now be responsible to do necessary baggage screening with advanced screening equipment for bombs, weapons or other materials. The baggage company may do the screening working with the airport authorities and other Federal Aviation Administration regulators as may be required. Once the luggage has been screened, it will be routed for transportation to the appropriate luggage air carrier that transports it to the required destinations.

An additional benefit of having independent baggage carriers is that the passenger airlines will not need to deploy any resources for baggage handling or tracking or loading or screening and thereby have significant savings to their operations. This may allow them to allocate more resources towards screening the passengers to further tighten security.

Independent baggage carriers may be able to generate economies of scale by carrying luggage for multiple airlines to the same destination. This will drive their costs of operations down, and allow them to bill the luggage charges to multiple airlines based on the cost sharing arrangements that are negotiated with each passenger airline.

Baggage transportation companies may choose to merge the airport checked bags with those picked-up from other locations at the airports at their choosing. They will be responsible to ensure the screening of the bags in these cases and also tracking the passenger departure if needed for security reasons. They will be responsible to deliver the bags to the proper destinations at the committed time.

Baggage Delivery

Baggage transportation companies will deliver the luggage at the destination selected by the passengers. They will route the baggage to the appropriate baggage arrival terminal or designated areas in the passenger terminals. The passengers will be able to pick-up the bags routed to the conveyer belts designated for their passenger airline for ease of identification and pick-up of the baggage. This process will seem very similar to the current method of baggage delivery to the travelers. The main difference will be that the baggage would have been transported on a dedicated baggage carrier other than the passenger aircraft, thereby significantly improving the air travel safety and security.

Baggage may also be delivered to some alternate destination chosen by the passenger if such a service is available and the passenger selects this service. Such a service may be offered at special rates that the passengers will pay for, over and above their normal airline ticket cost. Such a service may also be offered free by the passenger airline as an incentive to travel on that airline.

Passenger Travel

As discussed previously, passengers will normally travel without any carry-on or checked-in baggage in implementations of our invention. This will significantly increase their safety and security while in flight. The passengers would be able to order any special services that they needed from those offered by the airlines for a fee or otherwise. These services may include but not limited to laptops/notebook computers, phones, books, magazines or other accessories. These services will be provided similar to serving the beverage and meals on the airline.

On an exception basis, passengers may be allowed to carry some items with them onto the airplane if allowed by airline safety regulations in effect at that time. For example, as previously discussed, medical/health supplies may be allowed onboard, once that passenger has gone through extra screening at the airport terminal before boarding the airline.

The passenger travel is not affected other than some of the changes indicated above. The biggest benefit and change resulting from the implementation of this system is a significantly improved airline travel safety and security for the travelers.

Other Applications

While this invention is explained primarily in terms of airline travel, it is applicable not only to airlines. It is equally applicable to land, water and space travel, where security is a desirable factor. In describing our invention, use of the term “carrier” usually refers to airlines but can equally mean, bus carrier, rail carrier, ship carrier or spacecraft carrier, depending on the application in which a person chooses to implement our invention. The term “mode of travel” usually refers to an airline flight but can equally mean a particularly scheduled bus, train, watercraft, such as ship or boat, or spacecraft.

### BRIEF DESCRIPTION OF THE DRAWINGS

FIG. 1 illustrates travel paths for the passenger flight and the luggage flight of this invention, including the connections through hubs/airports.

FIG. 2 illustrates airlines using secure flights and normal flights in the same airport terminal with various methods and systems of this invention.

FIG. 3 illustrates airlines using a purely secure flight, with an airport terminal implementing various methods and systems of this invention.

FIG. 4 illustrates a secure departure flow of this invention for the passengers and luggage.

FIG. 5 illustrates the passenger arrival and luggage arrival for a secure flight implementing various methods and systems of this invention.

FIG. 6 illustrates passenger and luggage check-in flow for a secure flight implementing various methods and systems of this invention.

FIG. 7 illustrates passenger security check-in flow at the departing terminal implementing methods and systems of this invention.

FIG. 8 illustrates a seat assignment process for implementing a secure seat assignment method of this invention.

FIG. 9 illustrates a passenger departure process for an airline implementing various methods and systems of this invention.

FIG. 10 illustrates the flow of luggage routing, screening and departure of this invention.

FIG. 11 illustrates airline ticket reservation and purchase flow for a secure flight implementing various methods and systems of this invention.

FIG. 12 illustrates the detailed ticket reservation and purchase flow for various modes of ticketing for a secure flight implementing various methods and systems of this invention.

FIG. 13 illustrates various computer systems and their interconnections for implementation of this invention.

### DETAILED DESCRIPTION OF PREFERRED EMBODIMENTS

This invention is a new way of travel on the airlines. The main issue of airline security risk comes from the checked baggage or carry-on baggage. This invention will change the practice of carrying the luggage of the passengers in the airplane with the passengers. Every passenger who travels needs to transport his or her bags but that baggage does not have to fly with the passenger. Our secure air travel invention eliminates these security risks by not allowing checked baggage on the passenger airliners. This invention creates two separate categories of carriers or two categories of flights on individual carriers. In one example of our invention, one category of airline transports passengers only and a second category of airline transports luggage but no passengers between various locations. Alternatively, the same airline can offer passenger-only flights and luggage-only flights. Carriers that transport luggage only between the corresponding destinations are called “companion carriers.” Likewise, the flights that transport luggage on carriers that offer both types of flights are called “companion flights.” Eliminating the carry-on and checked bags on the passenger-only flights essentially eliminates the security risks from weapons, bombs or other hazardous materials concealed in bags.

The terms “bags,” “baggage” and “luggage” are used interchangeably throughout this patent and mean the same unless clearly indicated as to mean anything different. The term “travelers” means both passengers and crew. The term “passengers” does not include crew. The term “secure air travel” is used to mean traveling on secure flights. The term “secure flights” means secure passenger flights and secure baggage flights. Secure passenger flights are flights that transport passengers but do not transport baggage other than pre-authorized or pre-approved carry-on baggage. Secure baggage flights are flights that transport baggage but do not transport passengers. These secure baggage flights are sometimes termed companion flights or baggage-only flights or luggage flights in this patent. Airlines that provide secure baggage flights only are sometimes termed “baggage carrier airlines.” The term “normal air travel” means air travel on flights that transport both passengers and their baggage. Certain figures of this patent illustrate various aspects of an airline terminal to show features of this invention. Those of ordinary skill in the art can configure terminals different from those illustrated by adding, deleting or changing features and still not depart from the coverage of our invention.

This system can be implemented in a variety of forms to provide secure air travel. Following are some of the embodiments that implement this invention:

First Preferred Embodiment

A new system of airlines and airports/terminals separates passengers and luggage and transports them from source to destination on separate flights. This would require substantial change to the existing air travel system and would take longer to implement.

Second Preferred Embodiment

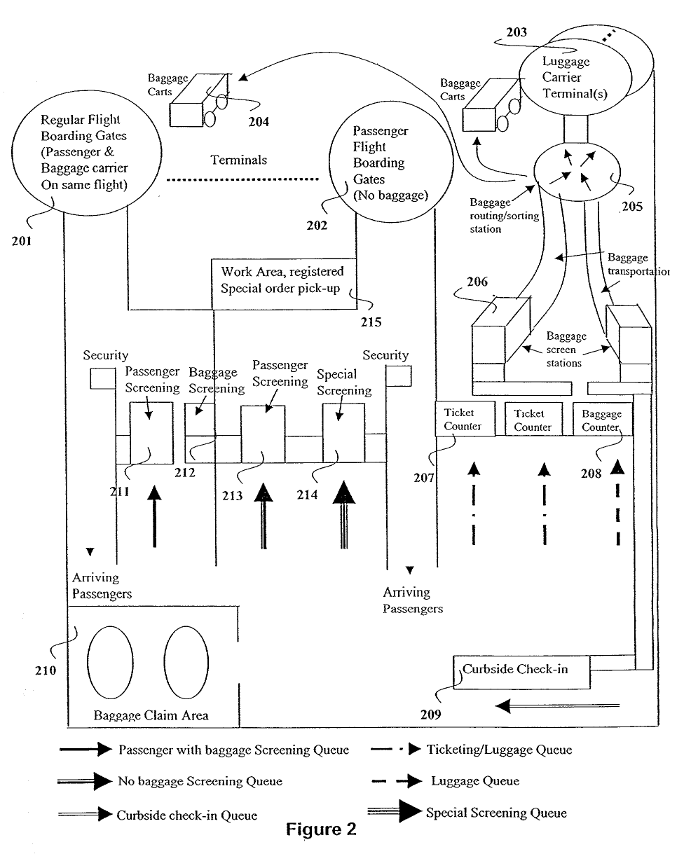

A second implementation of this invention can co-exist with the current air travel system. In this embodiment, current airlines or new airlines may implement this invention and offer special no-luggage passenger flights with luggage transported on companion flights for these special no-luggage passenger flights. Thus the airlines will be able concurrently to offer secure and normal air travel to passengers. The passengers can now choose the mode of travel they prefer, secure or normal. Airlines may be able to charge different airfares and may also be able to offer different special services on the secure flights. The method of check-in for the secure flights and normal flights will be different. This embodiment where secure air travel and normal travel co-exist on or within the same airline would require airports and airline systems to implement methods and systems of this invention to enable this mode of travel. FIG. 2, discussed subsequently, illustrates this embodiment of our invention.

Third Preferred Embodiment

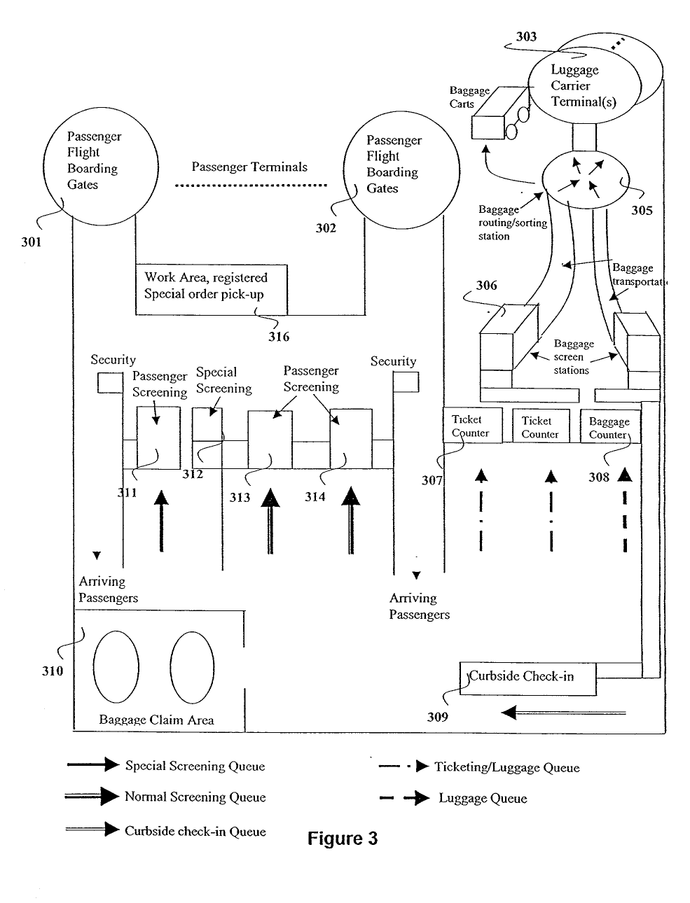

Another embodiment of this invention would include new airlines that offer primarily only the secure mode of travel and can co-exist with airlines offering normal (or both normal and secure) air travel modes. These new airlines may build terminals and systems that are for pure secure air travel implementation as illustrated in FIG. 3. These airlines may also be able to co-exist on the same airport terminals as the normal airlines by implementing a system like that illustrated in FIG. 2.

Detailed Description

The luggage of the passengers will be carried on separate planes from the passenger planes. The passenger airlines may own and operate the luggage carriers or there may be separate luggage airline carriers. These luggage carriers, the companion carriers, can carry luggage for multiple passenger carrier airlines between two airports for efficiency and economies of scale. Companion carriers may also be dedicated to a specific passenger airline based on the economics involved.

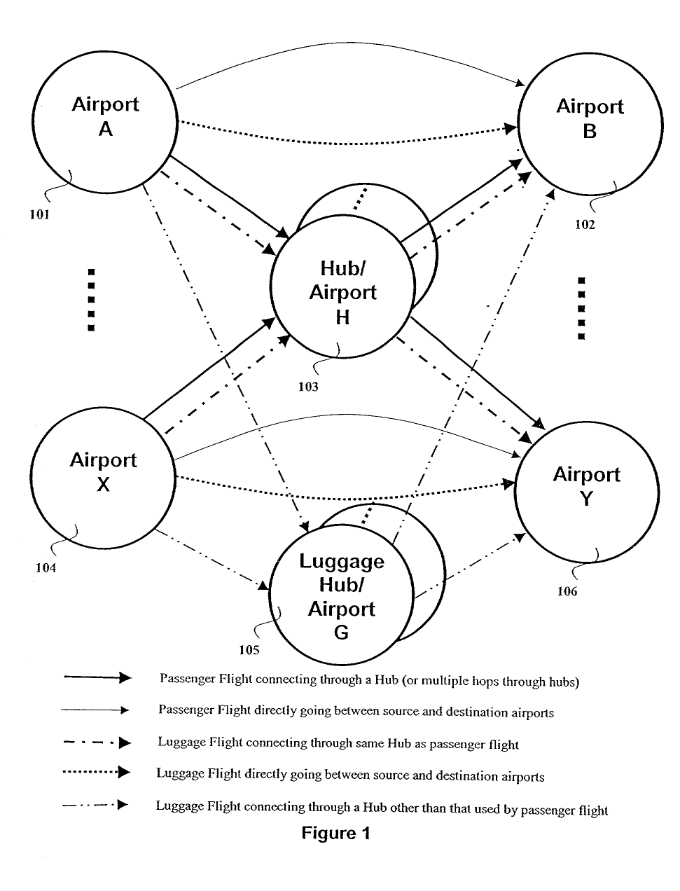

FIG. 1 indicates the flight paths for the passenger and the luggage flight carriers. The figure illustrates multiple airports and hubs. The arrows and arcs are the flight paths between the various airports. The figure illustrates multiple flight paths between sources and destinations. The Flight paths are illustrated going from left to right, and those going from right to left (from airports B to A or Y to X) or up and down (between airports A and X or Y and B) are not illustrated for simplicity of the figure. Those flight paths may or may not exist depending on the carriers serving those destinations and other reasons. That is, not all source and destination airports may be connected to each other via the same airline.

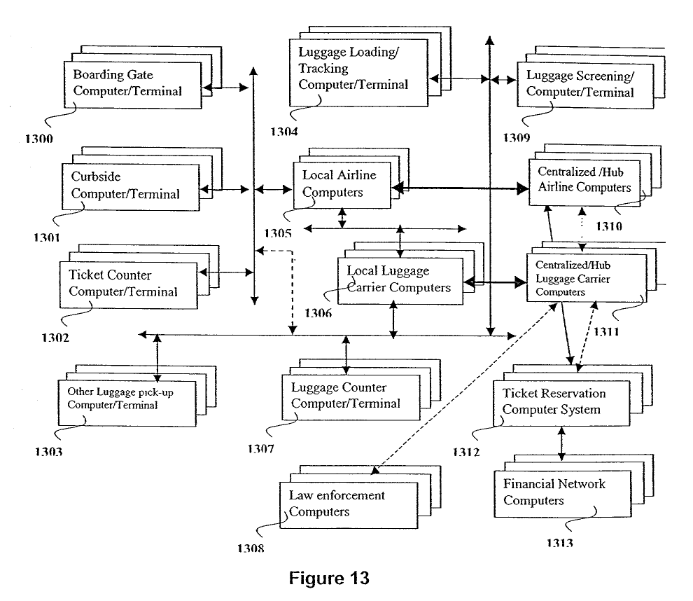

The arrows and arcs of FIG. 1 are illustrated as thick line, dotted lines, dotted-dashed lines, and the like, with the legend illustrated below the figure. The solid thick lines show the path of passenger flights from a source to a destination through a hub, whereas the thin solid lines show a direct flight path from source to destination. The luggage flights have the legends as indicated below the figure. For example if the departing airport is A and the destination airport is B, then the passenger flight may fly directly between the two points or may go through a hub or multiple hubs as illustrated by block 103 of the FIG. 1. The corresponding luggage flights may follow the same route or use a different route. The luggage flight may go through a completely different hub(s) as illustrated by one of the paths between airport A and airport B going through block 105. The flight path information for passenger flights and for luggage flights may be recorded in the airline and luggage carrier computers illustrated in FIG. 13, discussed subsequently, for their respective flights, for tracking and traffic control and other purposes like ground support crew information, planning, and the like.

Turning to FIG. 1 in greater detail, blocks 101 and 104 represent the departing airports, 102 and 106 represent destination airports, 103 represents the connection hub airport for passenger and luggage flights and 105 represents a luggage hub and/or connection hub/airport for the secure flights. As illustrated in the figure there can be a plurality of such airports and airlines implementing this system. Various routes of travel from source to destination are illustrated in the figure. An airline implementing this invention transports the passenger on a flight separate from the luggage as indicated earlier. The luggage is transported on a luggage carrier or flight from the source to the destination of the passenger flight. However, as illustrated in the FIG. 1, the luggage flight and the passenger flight may take the same route from source to destination or may take different routes. For instance, when traveling from airport X, block 104, to airport Y, block 106, the passenger flight may go directly between source and destination or may use hub/airport H, block 103, as an intermediate stop or flight change for passengers. There may be multiple hops before reaching the destination, block 106. Corresponding luggage flight may go through the same hub H, block 103, or fly directly to the destination, block 106, or fly through some other luggage hub or airport G, block 105. The luggage flight may also take multiple hops en route to the destination.

Various computer systems that track the passenger flights and luggage flights will be coordinated to enable this travel system and the luggage flow at various places at the departing and arriving airports, passenger and luggage hubs, and the associated airline computers through a mechanism similar to that illustrated in FIG. 13. Passengers may be able to change their flight plans in mid-course and request the luggage to be transported to the new destination. This could be coordinated using luggage tracking and passenger matching systems.

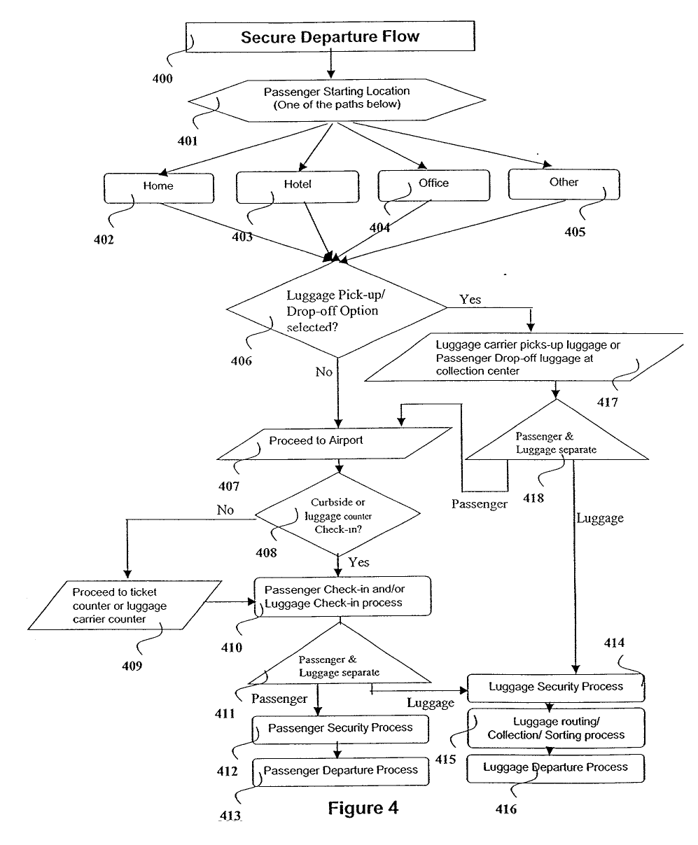

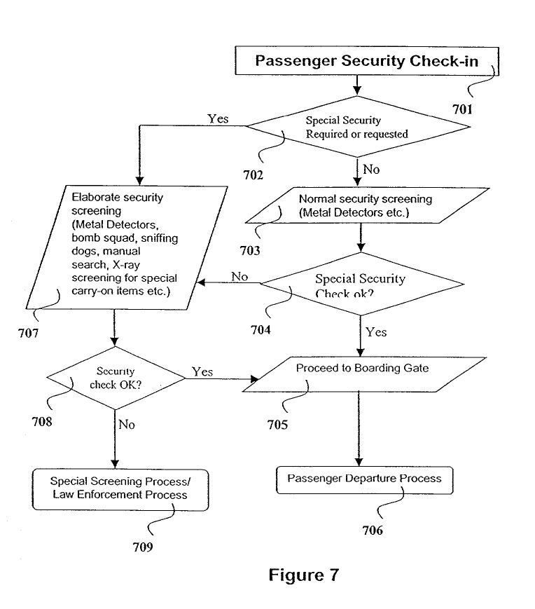

FIG. 2 illustrates an implementation of this invention comprising normal and secure air travel flights. Normal flights mean flights that transport both passengers and checked-in baggage. Secure flights are of two types. One type is a secure passenger flight. A secure passenger flight is a flight that transports passengers and no baggage other than pre-approved carry-on baggage. A second type of secure flight is a secure baggage flight. A secure baggage flight is a flight that transports baggage and no passengers. FIG. 2 illustrates various systems that are implemented for this invention. Block 201 represents the terminal gates where normal flights (passenger and luggage on same plane) depart. Passengers boarding on those flights go through the normal security mechanisms through passenger screening and baggage screening systems like in 211 and 212. There may also be special sections of the terminals where secure air flights depart. For these flights, passengers go through separate screening systems and queues, like in 213. There may be special screening sections, like 214, implemented for passengers needing special security checks, e.g. if health related carry-on's have to be boarded on the passenger flights or other items as may be allowed by law. Section 213 and 214 would be implementing secure air travel check-in procedure and system as illustrated in FIG. 7. The terminal illustrated would have a separated section for passenger only flights as illustrated in block 202. The passengers traveling on such flights would check-in their baggage either at curbside, 209, ticket counters, 207, or baggage counters, 208. Here the baggage and the ticketing process implements the system illustrated in FIGS. 4, 10, 11, 12, 13, to be discussed subsequently. The baggage of the passengers on the secure flight gets transported to the chosen luggage carrier flight from the curbside or various counters, through the luggage screening systems, 206, and routed to the luggage carriers on the luggage carrier terminals, 203. The bags may be transported using carts or conveyor belts or other mechanisms to the luggage carrier. The baggage is transported based on the identifying baggage tracking system implemented for secure air travel method. Routing and sorting of the bags may be done at a routing station, 205, or at the luggage terminal or at the screening stations. The Luggage carrier terminals may be conventional terminals or other type of terminals designed to make luggage loading and routing more convenient.

The baggage of passengers traveling on the normal flights would be transported from the curbside, ticketing counter through the security screening devices to the flights at the boarding gates as done currently.

FIG. 3 illustrates an implementation for this invention for secure air travel with all flights of the terminal illustrated implementing the secure air travel method. Block 301 and 302 represent the terminal gates from which the passengers board the flights. These flights do not carry any luggage on them including no carry-on items except by pre-authorized exception. The passenger luggage is transported on a separate luggage flight that gets loaded on the luggage carrier terminal represented by 303. Here the passengers go through the passenger screening systems (like metal detectors), represented by 313 and 314, and passengers that need special screening either because their passenger screen failed or they are carrying health related items as carry-on's or other legally allowed items on board, go through the special screening systems, represented by 311 and 312. Blocks 311, 312, 313 and 314 would be implementing secure air travel check-in procedure and system as illustrated in FIG. 7. The passengers traveling on these flights would check-in their baggage either at curbside, 309, ticket counters, 307, or baggage counters, 308. Here the baggage and the ticketing process implements the system illustrated in FIGS. 4, 10, 11, 12 and 13. The baggage of the passengers on the secure flight gets transported to the chosen luggage carrier flight from the curbside or various counters, through the luggage screening systems, 306, and routed to the luggage carrier on the luggage carrier terminal, 303. The bags may be transported using carts or conveyor belts or other mechanisms to the luggage carrier. The baggage is transported based on the identifying baggage tracking system implemented for secure air travel method. Routing and sorting of the bags may be done at a routing stations, 305, or at the luggage terminal or at the screening stations. The Luggage carrier terminals may be conventional terminals or other type of terminals designed to make luggage loading and routing more convenient.

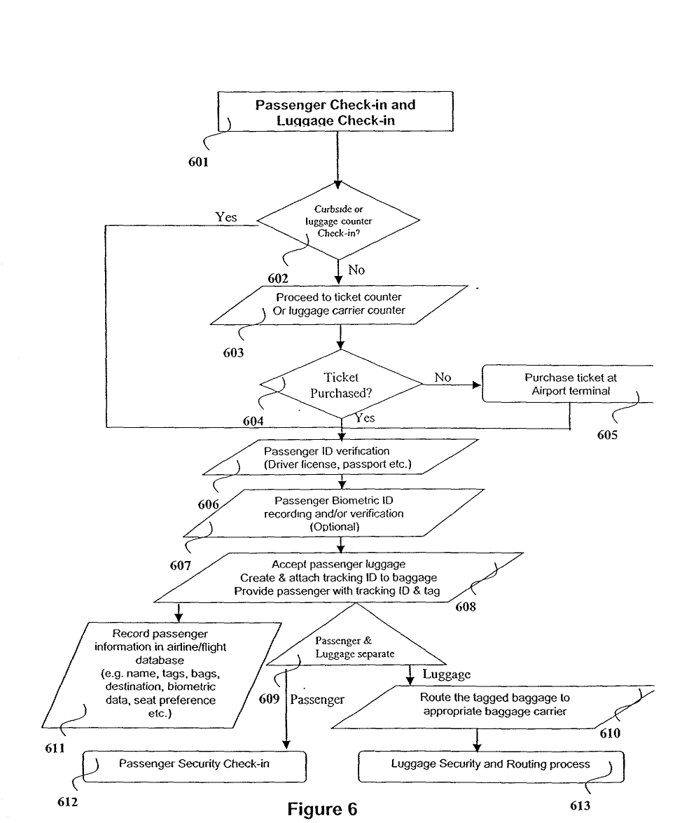

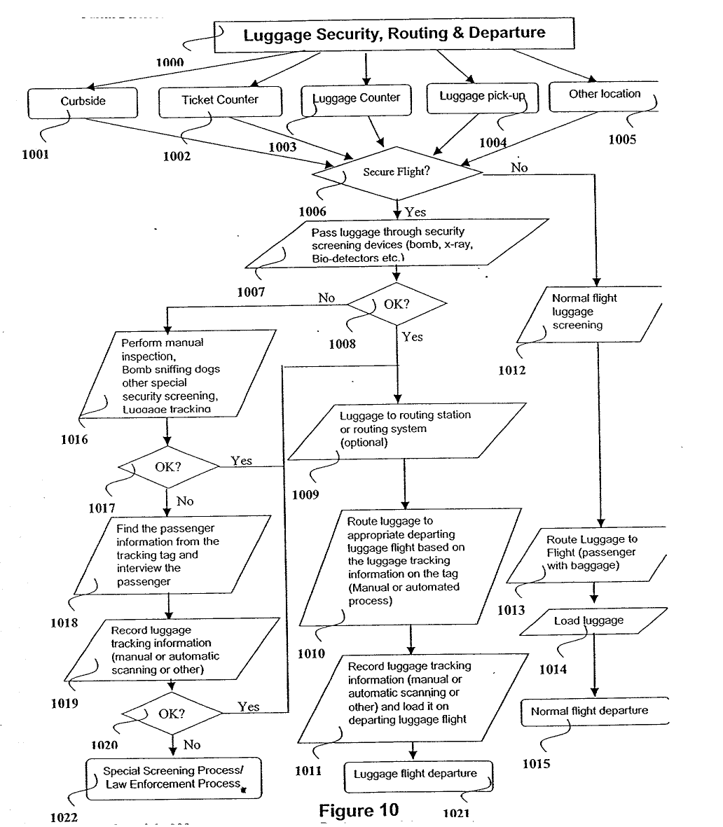

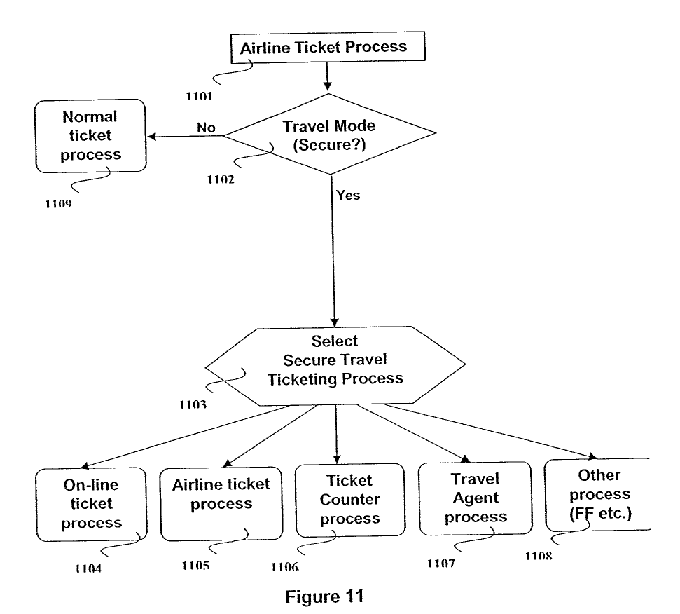

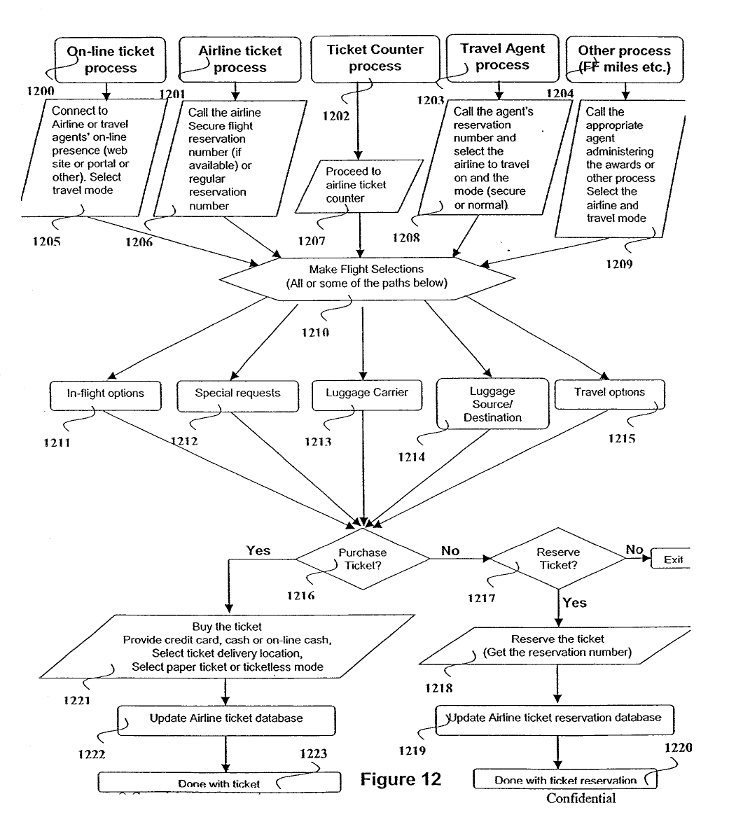

FIG. 4 illustrates the secure air travel departure flow. Here the passenger is assumed to have gone through the ticketing flow illustrated in FIGS. 11 and 12. The passenger may have bought a ticket, reserved a ticket and selected various other options including luggage pick-up and drop-off options. The figure illustrates multiple places where the passenger may depart from e.g. home (402), hotel (403), office (404), and other (405). If the passenger had chosen to have a luggage carrier company pick-up the luggage from the starting location or drop-off the luggage at a collection center, then the departure flow would follow the “yes” decision path of the block 406 and proceed to the block 417. As the luggage is either dropped-off or picked-up, the passenger proceeds to the airport, block 407, and the luggage is routed to the luggage security process at the airport, block 414. If the luggage pick-up/drop-off option were not chosen, the passenger proceeds to the airport with the luggage, block 407. At the airport, the passenger decides if curbside check-in or luggage counter check-in is done or ticket needs to be purchased. Based on that test, block 408, the passenger proceeds to ticket counter if curbside check-in is not the option. At the ticket counter the passenger goes through the airline ticketing and luggage check-in flows illustrated in FIGS. 6 and 12, discussed subsequently, represented by block 410 in FIG. 4. At the ticket counter, luggage counter or the curbside, the passenger and the luggage are separated as in block 411. The passenger flight record is entered, the baggage tracking information is also entered in the airline and luggage carrier local and central computer systems and associated databases as illustrated in FIG. 13. The passenger proceeds to the passenger security and departure steps illustrated in blocks 412 and 413, which represent the flows of FIGS. 7, 8 and 9, discussed subsequently. On the other hand, the luggage from various collection points, curbside, ticket counter, baggage counter or collection center is routed to the luggage security screening represented by block 414. The luggage is transported to a routing and/or sorting station from where it is transported and loaded on to the luggage flight. The routing and sorting station function may be performed at the luggage screening station or at the luggage carrier terminal. The luggage routing, screening and security flow is illustrated in more detail in FIG. 10.

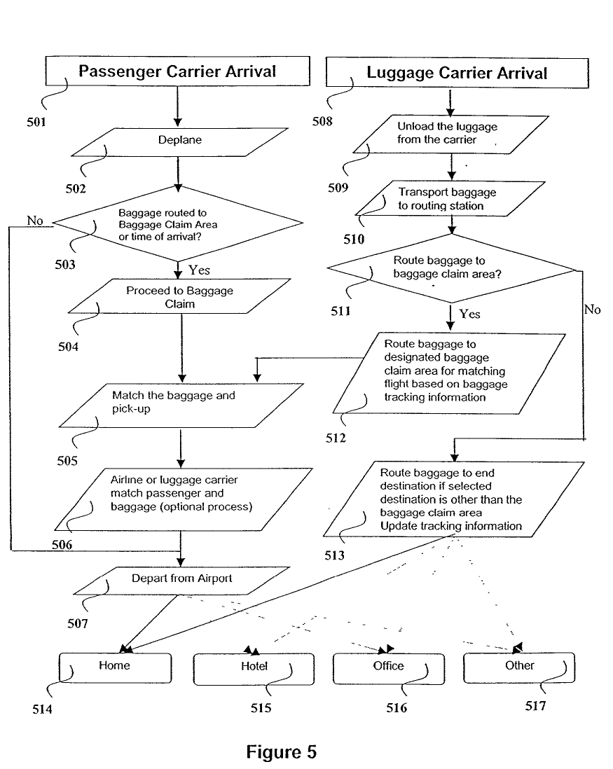

FIG. 5 illustrates the passenger and luggage arrival flow for the secure travel implementation. The passenger carrier and the luggage carrier arrive at their respective terminals. The passengers deplane at the gate as illustrated in block 502. If the baggage was going to be routed to the baggage claim area, the passenger proceeds to the baggage claim as illustrated in 503 and 504. If the baggage is to be delivered at some other destination, the passenger departs from the airport. When the luggage arrives on the luggage carrier, it is routed to the appropriate airline and passenger flight luggage carrousel in the baggage claim area. The baggage is routed there using the routing information on the baggage tag attached to the baggage as per the block 512. If the baggage is to be routed to a destination other than the baggage claim, then it is routed to those destinations as per block 513. If the luggage is routed to the baggage claim area, the passenger can pick-up the luggage as normal, matching the luggage with the luggage tags and tracking information with the passenger and on the luggage. The airline or the airport terminal authorities may also do an optional match to ensure that the rightful owner received the baggage. The baggage routing systems make note of the location of the baggage at each appropriate step to track the luggage. This would involve updating the location information in the luggage carrier computers as illustrated in FIG. 13, from where the airlines and luggage carriers can query the location of the baggage and track down missing or lost baggage.

If the baggage was to be delivered at an alternate destination in accordance with the luggage options chosen or if the time at which the luggage was to be delivered is different than the passenger flight arrival, the passenger departs from the airport. The passenger may come to pick-up the luggage at the airport at the designated luggage arrival time, if it is different than the passenger flight. This may be an option selected by passengers if their total travel fare is reduced by selecting baggage arrival to be different than passenger arrival time or fixed times or is more convenient to pick-up the baggage at a different time. The luggage carriers could offer such options. This invention provides separate transport of the luggage from the passenger flights and the time of arrival is expected to be the same as the passenger arrival. But there could be other options as indicated above. The luggage arrival schedules would be coordinated with the passenger arrival and departure times, by the luggage carriers and passenger carriers, and would be implemented as automated checks and coordination using their respective computer systems informing each other of the schedules and changes under direction of the operators. This system would be implemented as part of the FIG. 13 that illustrates various computer systems interacting and interfacing with each other.

Passenger check-in and luggage check-in flow is illustrated in more detail in FIG. 6. The passenger proceeds to the airline ticket counter or the luggage counter/curbside check-in based on the test illustrated in block 602. If the ticket needs to be purchased, the passenger goes to the ticket counter and purchases the ticket through the ticket flow represented in block 605 and illustrated in detail in FIGS. 11 and 12. The flow of the check-in is the same once the ticket is purchased. At the appropriate counter, the passenger does the luggage check-in, where the passenger ID verification is done like in 606 and 607. These identification and verification steps may include driver license, picture ID, passport, biometric ID like finger scan, iris scan and/or voice. This ID information is recorded in the computer systems, if required, and the baggage is accepted from the passenger. Baggage tracking ID and tag are created which are assigned to the passenger as a tag on the ticket or a tag to present at the destination airport. This ID and corresponding tag is attached to the baggage for tracking and routing of the luggage. The ID may include a large unique number created for the route and is associated with the passenger name, airline, flight(s), date of travel, destination, origin, luggage carrier name, luggage flight numbers, the luggage route, delivery time, end destination, passenger ID and other information and is recorded in the luggage carrier computer systems and the airline computer systems. The luggage tracking ID could in a barcode form on the tag or may be in the form of various tracking fields like origin, destination, luggage carrier, passenger carrier, passenger ID, and the like, printed on the baggage tag to make it easy to identify, route and track the luggage. The tracking ID is used to match the luggage and the passenger in the passenger systems and the luggage tracking systems. At this stage the passenger proceeds to the passenger security check-in where as the luggage is routed to the departing luggage carrier flight going through the screening and security steps as illustrated in blocks 610 and 611.

The passengers go through a security check-in procedure illustrated in FIG. 7. This security check-in process will be much smoother, efficient and more complete compared to recently implemented security measures after the events of Sep. 11, 2001. The passengers are not allowed to carry any baggage onto the plane. Hence, the security checks are concentrated on the items carried in person, for example keys, wallets, purses, cell phones, and the like. The passengers pass through security screening systems like metal detectors, bomb detectors, and the like, that will be deployed in the security check-in area. Most passengers will go through this mechanism, and will be able to go through it fast. Only when the security check fails or if the security guards at the check-in post suspect additional checks are required, would the passengers be subjected to elaborate checks. This is illustrated by the test in box 702 of FIG. 7. Additional security checks may be required if the passenger needs to carry legally allowed carry-on items and/or health related items. These passengers go through a special screening process illustrated in box 707. The elaborate security screening may include, metal detectors, bomb detectors, bio detectors, bomb sniffing dogs, manual search, multiple interviews, X-ray detectors for luggage and appropriate detectors for the passengers. If the passenger passes these checks without security breach, the passenger is allowed to proceed to the boarding gate as illustrated in boxes 708 and 705. However, if the passenger security check indicates a security breach, or possible security breach, additional steps may be taken including law enforcement checks as required by the Federal Aviation Administration security guidelines or other laws in effect at the time. The passengers going through the elaborate security checks may be required to allocate more time for check-in compared to those going through the more time efficient security screening process of step of box 703. If the normal screening illustrated in box 703, is free from security breach indication, the passenger is allowed to proceed to the boarding gate area for passenger departure. The checks of box 703 may include metal detector and other efficient automated checks for additional threats detected from time to time.

The passengers may be required to obtain a seat assignment and boarding pass at the boarding gates. This process may be the same as currently implemented in normal airline travel or may include that described here. To increase the security of the passengers, the seat assignment may not be made until some time period before departure. Also, the seats may be assigned randomly or substantially randomly, to prevent threats from seat assignments known ahead of time that may be used by terrorists to hide weapons in those flights ahead of time. Random seat assignment is optional. However, the passenger seat assignment information will still need to be recorded in the secure passenger flight/airline database. If the passenger already has a seat assigned ahead of time through ticket reservation, the boarding pass will be generated as in step 807. If the passenger needs to be assigned a seat and this is not a random seat assignment process, then assign the requested seat, if available, as illustrated in step 812, record the passenger information in the flight/airline database and generate the boarding pass. If the flight or airline implements the random seat assignment then, the passenger would not have a pre-assigned seat numbers and would go through steps 804, 805, 806 and 807 to get the seat assignment done and boarding pass generated. If all the passengers have been assigned their seats or the departure time has arrived, the seat assignment and boarding passes are stopped from being issued, otherwise the attendant at the boarding gate computer keeps serving the passengers in the queue. Prior to departure, the airline computer systems are updated with the final list of passengers boarded on the flight and the flight manifest is generated as illustrated in step 810.

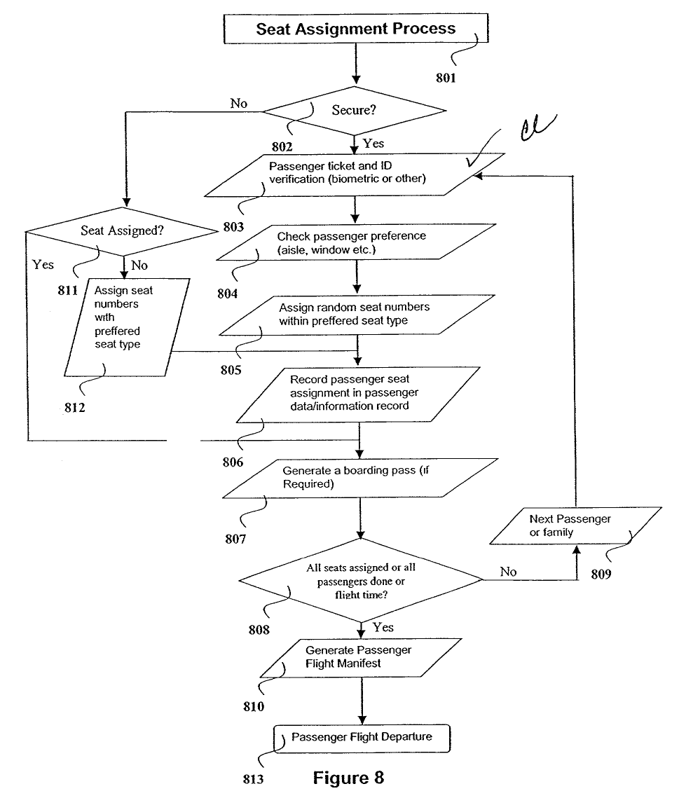

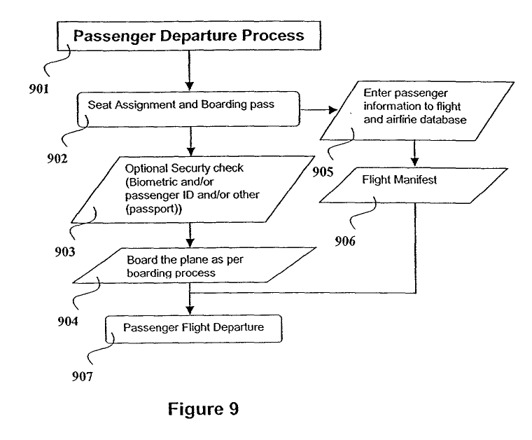

FIG. 9 illustrates the passenger departure process at a higher level of abstraction than the FIG. 8. FIG. 9 illustrates the passenger departure flow from the departing airport. The passenger after going through the security screening process at the terminal entrance proceeds to the gate to receive the boarding pass if it is not assigned at the ticket counter. At the boarding gate, the passenger may be asked for identification and may be required to go through biometric security check, finger print scan, or iris scan, and the like. Then the boarding pass would be issued. If the seat assignment was not made earlier or if the airline implements the secure seat assignment process then the passenger would get the seat assignment as illustrated in FIG. 8. Once the seat assignment is completed, the boarding pass is generated the passenger boards the aircraft when called by the flight attendant. The flight manifest may be generated before the departure of the flight. The passenger seat assignment information is updated in the airline computers illustrated in FIG. 13. Also, the flight manifest may be generated after all the passengers have boarded the aircraft. The airline computer systems are updated with the latest flight information, including the passenger list, and the like, as a record from which the flight manifest can be created when needed. This information may be recorded in the computer systems and otherwise as paper printouts as required by the Federal Aviation Administration regulations that the airlines would be required to follow.

Luggage is routed, screened and loaded on the luggage flight using the flow illustrated in FIG. 10. The luggage may be collected from the passenger at one of the collections places like curbside (1001), ticket counters (1002), luggage counters (1003), luggage pick-ups (1004) or other location (1005) like car rental, airport shuttle or others. If this luggage is destined for the luggage flight it passes through the “Yes” path at step 1006, otherwise it proceeds through the “No” path. If the luggage is meant for a regular flight (passenger and luggage on same plane), it will go through the normal flight luggage screening process and is routed to the flight and loaded onto the flight. However, if the luggage is destined for a secure travel flight, it goes through the luggage security screening devices like X-ray detectors, bomb detectors, biohazard detectors and others as required by the Federal Aviation Administration regulations. If the security screening does not indicate a security breach, the luggage is routed to the appropriate departing luggage flight based on the luggage routing and tracking tags in an automated or manual method. The routing step may be implemented at the screening station or at the luggage terminal. Luggage loading and screening information is recorded in the computer system of the luggage carrier like in step 1011, to enable efficient luggage tracking. The luggage is loaded onto the designated luggage flight. The luggage flight may be dedicated to the specific airline or may be able to accept luggage for multiple airlines. In case the security check indicates there may be a security breach at step 1008, then additional luggage screening is performed as illustrated in step 1016 before letting the luggage get routed. If this check indicates there may be a security breach, then the passenger information is extracted from the tracking system, using the baggage tracking ID and associated passenger information. The passenger may then be interviewed prior to departure of the passenger flight and if all checks are clear then the luggage and the passenger would be allowed to depart on their respective flights. Otherwise, special screening and law enforcement steps may be required as illustrated in step 1022.

FIGS. 11 and 12 show the airline ticket process for airlines implementing a secure flight coexisting with normal flights, implementing a pure secure flight system, or any other options of secure flights as indicated earlier. If the passenger wants a secure mode of travel, then (s)he proceeds to step 1103. If this is a normal flight, a normal ticket process may be used. The airlines, travel agents, online, airline ticket counters or other ticketing agents offering normal flight tickets may implement this process or a modified process where a check for secure versus a normal flight is made and the secure flight reservation steps are taken. The flow and the information recorded may vary depending on the options offered.

FIG. 12 is a continuation of FIG. 11. The passenger selects the appropriate travel mode and the ticketing mode and follows that path as illustrated in FIG. 12, steps 1200 through 1209. The passenger then moves on to select various flight options illustrated in steps 1211 through 1215. The passenger may choose all or some of the options as desired and the order in which each is implemented by the reservation system of the airline or by the agent. The passenger is required to select some of the paths like the flight options. This step may include the following but may include more items:

| | |
|---|---|
| 1. | Airline |
| 2. | Flight time |
| 3. | Date of departure and/or arrival |
| 4. | Travel origin and destination |
| 5. | Stop over (if any) |
| 6. | Class of travel (business or coach or other) |
| 7. | Fare range desired (if choice is offered) |
| 8. | Meal preference (if any) |
| 9. | Seat selection (window, aisle, and the like) |
| 10. | Number of passengers |
| 11. | Name of passengers and passenger information |
| 12. | Seat assigned |
| 13. | Other selections as appropriate (e.g. car, hotel, and the like) |
| 14. | Luggage carrier options |
| 15. | In-flight options, special requests |

The passenger would be able to choose the luggage carrier options, if available, including a different luggage carrier, place of luggage drop-off/pick-up at the source and the destination, and the like. The passenger may choose the default options like airport check-in and baggage claim pickup and the same airline for luggage as the passenger airline. The passenger will also be able to select options for any special requests and in-flight options as may be offered, including but not limited to notebooks, laptops, printer facility, books, magazines or any other items as may be offered by the passenger airline.

The passenger airlines may convert the cargo area in planes into additional seating area with pressurized cabin and/or may be able to convert that space into a working office like setup for the use of passengers with computer systems and other associated facilities like printers, network connections, Internet connections, mass storage devices, and the like. The passengers may be able to upload their data into secure systems of the airlines for them to be able to access information from the airlines if they choose, or be able to access the Internet directly in the flight (before, or during air travel) to be able to continue their work on the flight.

The passenger may also make additional selections for other needs like health items or other special carry-on's as allowed by the airline and the laws in effect at those times. This may trigger additional check-in time and steps required for the passenger during their departure from the terminal.

The traveler then chooses to purchase the ticket or just reserve it as illustrated in steps 1216 and 1217. The passenger reserves the ticket and gets a reservation number, with appropriate information about the selected secure travel options recorded in the reservation agent and airline computer databases using a computer network and connections like that illustrated in FIG. 13. The traveler may later on purchase the ticket either through the same process or at the terminal. If the traveler chooses to buy the ticket, (s)he follows the steps illustrated in 1221. Once the ticket is purchased, appropriate computer records are updated with the information, including the airline computer database, luggage carrier computer database, rental car, hotel database, and the like. The ticket is delivered to the traveler at the designated address by the mode selected e.g., paper ticket, e-ticket (if available), or ticketless travel confirmation, and the like.

FIG. 13 illustrates computer systems that can be used to track, record, route the luggage and the passengers for this secure air travel invention. The computer systems are illustrated as multiple computers in each location. The computers may be personal computers, thin clients, servers, workstations, handheld computers, scanning devices with microcontrollers installed, that may include display devices, network connections, key board entry, camera/scanner devices, fingerprint scanners, and other biometric input devices connected to them, with a local memory and storage devices. These computers may include textual entry mechanisms, windows based or menu based software, graphical user interfaces, web browser interface or a combination of these on various computer systems involved in the secure airline travel method. The computers are shown connected with each other using networks. Airline computers may be networked separately from the luggage carrier computers and/or they may all be on the same network implementing appropriate security and isolation mechanism. The networks connecting these computers could include local area networks (LANs), metro area networks (MANs), Wide area networks (WANs), wireless LANs (WLANs), wireless data networks, internetwork or other proprietary or open network connectivity or point to point links, and the like. The network connectivity is useful to provide the transfer of the secure air travel data for recording, tracking, ticket reservation and other purposes as described in the various descriptions earlier. The specific type of computer or the network is not critical as long as connectivity exists and the data transfer rates allow an efficient data exchange. The data and information records about the passenger tickets, passenger ID, other passenger and flight related information, baggage tracking data, baggage tracking ID, and the like, will be stored locally and centrally at different times in the local memory and/or mass storage devices. This data will be accessed (created, recorded, stored, retrieved, and the like) using a database toolsuite and other interface connecting these computer user interfaces to the database storing this data. The computer-to-computer data exchange may be implemented using EDI formats or XML or any other automated data sharing mechanisms. The data and the database records may also be backed-up and stored for permanent record or back-up purposes. Following is a list of some of the events and information that would be recorded; more events and information may be recorded in accordance with a particular airline's needs or with the needs of regulatory agencies:

| | |
|---|---|
| 1. | Ticket reservation with all the information |
| 2. | Ticket purchase and issue records |
| 3. | Passenger information (name, ID, DOB, and other data) |
| 4. | Airline, flights, luggage flights, stop over, flight tracking |
| 5. | Passenger ID, biometric, and the like, verification |
| | and verifier information |
| 6. | Boarding pass, seat assignment, flight manifest |
| 7. | Luggage tracking information |
| 8. | In-flight options selected |
| 9. | Luggage delivery tracking |
| 10. | Other similar descriptions |

Various computer systems include ticket counter computers, luggage counter terminals, boarding gate computers, curbside computers, local airline computers, central computers connecting various local computers for the airlines, financial network connections, law enforcement computers and connectivity to those, luggage carrier computers at the terminals, local computers, luggage scanning/screening, routing, and tracking computers, and ticket reservation computers.

FIG. 13 illustrates how various computer systems would implement the secure air travel invention. There are several combinations of this network of computers possible and would not be practical to describe all possible embodiments.

There are multiple classes of computers illustrated in the diagram. There is a set of computers at the terminals where there is interaction with the passenger and the person operating the computer/terminal e.g. boarding gate computers, curbside computers, ticket counter computers, luggage counter computers and other luggage pick-up location computers. There are ticket reservation computer systems which include the computers at the airline computer reservation center, the computers that the airline reservation agents use to enter the ticketing information when on the phone, the client computers that the passengers use from their home, office or other location to connect to the airline reservation system to do their reservation/ticketing on-line and also includes the computers that the travel agents and other agencies or entities use for reservation/ticketing by connecting to the computers at the airline computer reservation center(s). There is a set of computer systems/devices used by the luggage carriers (which could be the same airline company as the passenger carrier company) for tracking the baggage information in their systems. These include computers/terminals at the luggage counters at the airports, at luggage pick-up and delivery points, at luggage loading and screening, centralized and hub luggage carrier locations, and local luggage carrier terminals/airports. There is a set of computers for the airlines as well including those at the local airline terminals and airports and centralized and hub airport locations and other passenger interface locations and the ticket reservation system computers. Airline computers and the luggage carrier computers may also be connected to the law enforcement computers for verification of the passenger identity to prevent known/suspected criminal elements from boarding the airlines. This may also be required for checks for international travelers to verify their identities with the law enforcement agencies including immigration department to check their visa status and also to ensure no known criminal records.

The types of the computers is not critical, as long as there is a network that connects the appropriate computers with the required security and privacy measures/policies as deemed necessary by the various entities involved. Some of these computer systems may be the same set of computers for example if the airline carrying the passengers and the luggage is the same. In that case the local, hub and centralized computers could be the same for passenger and luggage tracking, ticketing, and the like. The set of computers shown here could be different per airline or some of them may be shared between multiple airlines. For example, the curbside check-in, boarding gate, luggage screening, and the like, computer systems could be shared between multiple airlines and the airport administration.

There may be private networks connecting computers of each entity and gateway computers/switches/routers/hubs connecting these networks with each other in a secure manner like implementing a common security protocol between each network that may be pre-negotiated before starting the data transfer between each other's computers. The users may be allowed to enter other networks through password protection and/or other authentication mechanisms. For instance, all computers belonging to one airline may be networked together in the airport using a dedicated local area network, and in turn these computers may be connected to the airline central computers through a private network using leased lines. The central computer systems may be distributed geographically for redundancy, faster access or other purposes but still serve the function of common central repository and processor of data related to the secure airline travel for passenger flights, luggage tracking, ticketing, reservation, and like purpose. The airline computers from each airport would be networked to the centralized computer systems. The network connecting the local airport computers to the centralized location or regional hubs may also be done using the public Internet, with right security mechanisms implemented at the local and central computer networks. A similar network may exist for the luggage carrier. The luggage carrier and the passenger airlines would share the tracking information with each other through their computers that may be interconnected with each other using a dedicated network connections or may use internetwork technologies. The data exchange may be possible by logging into the other network manually, or may be automated. The data exchange may use EDI format, XML, SGML or other data sharing protocols and algorithms deployed on these computers.

It is also possible that all the airlines or some of the airlines and the luggage carriers share the same local area network.

Following is one scenario of how various computer systems are used:

The first step starts with the passenger deciding to use a secure mode of air travel. Then (s)he decides to buy/reserve the ticket using the secure air travel ticketing process illustrated in FIGS. 11 and 12. As an example the passenger chooses to do on-line ticketing. The passenger uses a computer to connect to the ticket reservation computer system of the airline on the Internet or other networks. This computer system presents the secure airline ticketing flow options to the passenger as illustrated in FIG. 12. The secure air travel options are then recorded in the ticket reservation computers illustrated in box 1312 of FIG. 13 If the option of a different luggage carrier was chosen, then that information is delivered to the luggage carrier computers illustrated in blocks 1306 and 1311. This alerts the luggage carriers to make appropriate arrangement for the travel of the passenger as per the options chosen e.g. pick-up/drop-off the luggage at a certain time and place.

On the day of travel, the passenger arrives to the airport and if luggage option was to deliver the luggage at the airport, proceeds to the curbside check-in or ticket counter or luggage counter. The check-in process would be similar to that in FIG. 4 and FIG. 6. The passenger would be given a luggage tracking ID which may be derived from various fields as indicated earlier, that will be recorded in the luggage carrier computers and optionally the airline computers at the terminal and the departing airport as illustrated in FIG. 13. The luggage would flow through the luggage screening, routing and loading process like that illustrated in FIG. 10. The luggage carrier may track the status of the luggage as it passes through each of the critical steps as per legal requirements and its own internal distribution and routing purposes. This information is recorded in various computer systems as illustrated in FIG. 13, blocks 1304, 1309, 1306, and 1307. This information would also get reflected in the central luggage carrier computer systems illustrated in block 1311. This information would be referenced by the systems/operators at the hubs and/or the destination airport to route the baggage to the right destination. This information may also be used in case of lost baggage claims investigation and identification as well as for delayed baggage notification purposes beside other uses like billing, security tracking, and the like.

After checking in the baggage the passenger may proceed through the security check-in process and up to the boarding gate for seat assignment and departure processes as illustrated in FIG. 8 and FIG. 9. If the airline implements the secure seat assignment process than the steps illustrated in FIG. 8 may be followed. Prior to the flight departure a flight manifest for the secure flight would be generated and also recorded in the airline computers illustrated in block 1305 and 1310 from those computers/terminals illustrated in block 1300.

The passenger departs in the passenger flight and the luggage departs in the luggage flight from the departure airport en route to the destination. The luggage and the passenger flights may fly directly to their destination airport or may go through one or more intermediate hubs/stopover as illustrated in the FIG. 1. The hubs for the passenger airline and the luggage flight may be same, or may be different for several factors, for example if the two carrier airlines are different, or their passenger and luggage routes are different, and the like. The computer systems in FIG. 13 keep track of these flight routes in computers of block 1310 and 1311 along with those at the departing, arriving and hub computers. This is required to facilitate the transporting of passengers and their luggage to their end destinations. The passengers may be able to change their end destination, mid-course, and would be able to get their luggage routed to the appropriate destination. This would be accomplished using the luggage tracking ID, the passenger ticketing information and the data recorded in the passenger carrier and luggage carrier computers. The appropriate changes of the destination can be made in these systems and the luggage can be routed to the correct destination. The flight records of the passenger would be changed in the airline computers and also the necessary change will be indicated to the luggage carrier to change the end destination of the luggage. The tracking ID would reflect the change, or a new tracking ID could be issued. Either systems are possible.

When the passenger and the luggage arrive at the destination airport, they follow the process illustrated in FIG. 5. The luggage is unloaded and routed to its drop-off location as per the tracking ID. Once delivered the appropriate updates are made in the luggage carrier computer systems indicating the delivery of the luggage. The passenger carrier also makes the update to the flight record of completion of the secure air flight to the destination. This information is also recorded in the airline computer systems illustrated in FIG. 13.

While the foregoing has been with reference to particular embodiments of the invention, it will be appreciated by those skilled in the art that changes in these embodiments may be made without departing from the principles and spirit of the invention, the scope of which is defined by the appended claims.

We claim:

1. An airport terminal including (a) at least one passenger carrier area for passengers to be transported on passenger flights on which no baggage other than pre-approved carry-on baggage is transported and (b) at least one baggage area for baggage other than said pre-approved carry-on baggage associated with said passengers, said baggage to be transported on baggage flights on which no passengers are transported.

2. An airport terminal including (a) at least one passenger carrier area for passengers to be transported on passenger flights on which no baggage other than pre-approved carry-on baggage is transported, (b) at least one baggage area for baggage other than said pre-approved carry-on baggage associated with said passengers, said baggage to be transported on baggage flights on which no passengers are transported, (c) at least one passenger area for passengers to be transported on flights on which their baggage is also to be transported, and (d) at least one baggage area for baggage to be transported on said last named flights.

3. The airport terminal of claim 1 or 2 including additional security check facilities for screening and approving said pre-approved carry-on baggage.

4. The airport terminal of claim 3 wherein said airport is the airport of departure and has facilities for passengers to check-in their baggage for transport on said baggage flights (1) by accepting baggage at the airport check-in counter or (2) by accepting baggage picked-up from its origin departure location.

5. The airport terminal of claim 3 wherein the airport is the airport of arrival having facilities for delivering baggage to arriving passengers at said destination airport or at a final destination of said passengers.

6. The airport of claim 5 wherein said final destination is the passenger's home or place of business.

7. A travel departure and arrival terminal including (a) at least one passenger area for passengers transported on a passenger mode of travel on which no baggage other than pre-approved carry-on baggage is transported, and (b) at least one baggage area for baggage other than said pre-approved carry-on baggage, said baggage transported on a baggage mode of travel on which no passengers are transported.

8. A travel departure and arrival terminal including (a) at least one passenger area for passengers transported on a passenger mode of travel on which no baggage other than pre-approved carry-on baggage is transported, and (b) at lest one baggage area for baggage other than said pre-approved carry-on baggage, said baggage transported on a baggage mode of travel on which no passengers are transported, (c) at least one passenger area for passengers to be transported on a mode of travel on which their baggage is also to be transported, and (d) at least one baggage area for baggage to be transported on said last named mode of travel.

9. The terminal of claim 7 or 8 including additional security check facilities for approving said pre-approved carry-on baggage.

10. The travel departure and arrival terminal of claim 9 wherein travel is land travel.

11. The travel departure and arrival terminal of claim 10 wherein the mode of travel is a scheduled bus.

12. The travel departure and arrival terminal of claim 9 wherein travel is water travel.

13. The travel departure and arrival terminal of claim 12 wherein the mode of travel is a scheduled watercraft.

14. The travel and departure and arrival terminal of claim 9 wherein the travel is space travel.

15. An airline information system including multiple computers and multiple computer terminals for inputting data into any of said multiple computers for operating travel reservation, travel tracking, and flight scheduling processes, said information system including first computer storage containing data allowing passengers to select travel on carriers that provide for (a) passenger transportation on airline passenger flights on which no baggage other than pre-approved carry-on baggage is transported and (b) baggage transportation on baggage flights on which no passengers are transported, said selection accomplished by entering information into said information system through at least one of said multiple computer terminals.

16. The information system of claim 15 wherein said selection is accomplished by entering data through a class of said multiple computer terminals that is operated by travel agents.

17. The information system of claim 15 wherein said selection is accomplished by entering data through a class of said multiple computer terminals that is operated by the airline operating said passenger flights.

18. The information system of claim 15 wherein said selection is accomplished by entering data through one of said multiple computer terminals that is operated by the airline operating said passenger flights.

19. The information system of claim 15 further including second computer storage containing data corresponding to a list of locations at which passenger baggage will be picked up for delivery to said baggage flights, said locations being selected from the group of locations consisting of (1) check-in facilities at an airport and (2) the place of travel origin.

20. The System of claim 19 wherein said second computer storage is capable of accepting data corresponding to said locations, said data being input from one of the collection of computer terminals consisting of (a) a passenger's computer terminal, (b) computer terminals operated by an airline, or (c) computer terminals operated by travel agents.

21. The information system of claim 15 further including third computer storage containing data corresponding to a list of locations at which passenger baggage will be delivered after baggage flight arrival at a destination terminal, said locations selected from the group consisting of (1) the destination terminal and (2) a destination other than said destination terminal.

22. The information system of claim 21 wherein said third computer storage is capable of accepting said data corresponding to said list from one of the collection of computer terminals consisting of (a) a passenger's computer terminal, (b) a computer terminal operated by an airline, or (c) a computer terminal operated by a travel agent.

23. The information system of claim 15 further including fourth computer storage locations at which passengers may cause the inputting of data representing the passenger's request for general seat locations selected from the locations consisting of (a) a window seat, (b) an aisle seat, and (c) groups of seats.

24. The information system of claim 23 in which said inputting of data is accomplished by inputting data from one of the collection of computer terminals consisting of (a) a passenger's computer terminal, (b) a computer terminal operated by an airline, or (c) a computer terminal operated by a travel agent.

25. The information system of claim 24 wherein said information system records seats that are assigned to said passenger in said passenger's requested general seat locations after said passenger arrives at the departure terminal.

26. The information system of claim 15 wherein said information system further includes fifth computer storage for storing baggage tracking information for tracking baggage during travel on said flights on which no passengers are transported.

27. The information system of claim 26 wherein said information system issues said baggage tracking information to passengers for matching said baggage tracking numbers with baggage for pick-up after baggage arrival at a destination.

28. The information system of claim 15 further including scheduling software for scheduling (1) said passenger flights and (2) said baggage flights.

29. The information system of claim 28 wherein said scheduling software can schedule said passenger flights on one route and said baggage flights on a different route.

30. The information system of claim 28 wherein said scheduling software can schedule said passenger flights through one or more airline hubs and schedule said baggage flights through one or more different airline hubs.

31. The information system of claim 28 wherein said scheduling software can schedule a passenger flight and a baggage flight through the same one or more airline hubs.

32. The information system of claim 28 wherein said scheduling software can track requests from one or more passengers to change destination to a new destination and update information in said information system to cause the baggage of said one or more passengers to arrive at said new destination.

33. The information system of claim 28 in which said scheduling software can schedule one of said passenger flights with a predetermined number of flight legs and can schedule a baggage flight carrying baggage of the passengers on said one of said airline flights with a predetermined number of flight legs different than said predetermined number of flight legs of said one of said passenger flights.

34. An airport terminal including facilities for normal flights and facilities for secure flights.

35. The airport terminal of claim 34 wherein said facilities for normal flights include terminal gates from which normal flights depart and said facilities for secure flights include terminal gates from which secure flights depart.

36. The airport terminal of claim 34 wherein said facilities for normal flights include normal security mechanisms including passenger screening systems and baggage screening systems.

37. The airport terminal of claim 34 wherein said facilities for secure flights include a special, security screening facility having queues different from those for passengers using said normal facilities.

38. The airport terminal of claim 37 wherein said special, security screening facility includes screening for health related carry-on baggage or baggage allowed or required to be carried-on by law.

39. The airport terminal of claim 38 wherein said special, security screening facility includes screening processes taken from the group of screening processes consisting of metal detectors, bomb squad operations, sniffing dogs for the detection of explosives or drugs, and X-ray screening for approving carry-on items to be pre-approved before boarding said secure flight.

40. The airport terminal of claim 34 wherein said facilities for secure flights comprises a separate section for passengers traveling on said secure flights and a baggage section for baggage transported on baggage flights that do not transport passengers.

41. The airport terminal of claim 40 wherein said facilities for secure flights further include baggage check-in facilities that provide functions of transporting said baggage from any of the collection of check-in locations consisting of curbside, ticket counter and baggage counter.

42. The airport terminal of claim 41 wherein said baggage is transported through baggage screening systems to a baggage carrier by way of said baggage section.

43. The airport terminal of claim 42 where said baggage is transported using a mechanism selected from the group of mechanisms consisting of baggage carts and conveyor belts.

44. The airport terminal of claim 40 wherein said facilities for secure flights further include one or more facilities from the collection of facilities consisting of a baggage routing station, a baggage sorting station, a baggage terminal and a separate, security baggage screening facility.

45. An airport terminal having facilities for secure flights only.

46. The airport terminal of claim 45 wherein said secure flights include passenger flights and baggage flights.

47. The airport terminal of claim 45 wherein said facilities include terminal gates from which passengers board said secure flights.

48. The airport terminal of claim 45 including first screening facilities that passengers pass through, said first screening facilities further including special screening facilities including facilities for screening passengers who unsuccessfully pass through said first screening facilities.

49. The airport terminal of claim 48 wherein said special screening facilities further includes second facilities for pre-approving predetermined classes of carry-on baggage.

50. The airport terminal of claim 45 wherein passengers traveling on said secure flights check in their baggage at one or more locations selected from the collection of locations consisting of curbside, ticket counters, baggage counters, and other pick-up areas.

51. The airport terminal of claim 45 including at least one baggage screening station, at least one baggage routing and sorting station and at least one baggage terminal.

52. The airport terminal of claim 50 wherein said baggage is transported from said one or more locations to said at least one baggage screening station.

53. The airport terminal of claim 52 wherein said baggage is transported from said at least one baggage screening station to said at least one baggage routing and sorting station.

54. The airport terminal of claim 53 wherein said baggage is transported from said at least one baggage routing and sorting station to said at least one baggage terminal.

55. An information system including multiple computers, one or more of said multiple computers located at a departure airport and one or more of said multiple computers located remotely from said departure airport, said information system further including multiple computer terminals for inputting data into any of a said multiple computers for tracking and controlling a secure air travel departure process for passengers and baggage being transported on secure flights, said secure flights including secure passenger flights on which no baggage other than pre-approved carry-on baggage is transported and baggage flights on which no passengers are transported.

56. The information system of claim 55 including first computer storage for containing data representing a passenger's selection of a baggage pick-up location for baggage destined to a departure airport.

57. The information system of claim 56 wherein said data can be entered into said information system, said data being entered from one of the collection of computer terminals consisting of (a) a passenger's computer terminal, (b) a computer terminal operated by an airline, or (c) a computer terminal operated by a travel agent.

58. The information system of claim 55 including second computer storage for containing data representing a passenger's selection of a baggage drop-off location.

59. The information system of claim 58 said data being entered from one of the collection of computer terminals consisting of (a) a passenger's computer terminal, (b) a computer terminal operated by an airline, or (c) a computer terminal operated by a travel agent.

60. The information system of claim 55 including third computer storage for containing data representing information for tracking baggage through the departure process.

61. The information system of claim 60 wherein said third computer storage is contained one or more computers located at the departure airport.

62. The information system of claim 60 wherein said third computer storage is contained in one or more computers located remotely from the departing airport.

63. The information system of claim 62 wherein said one or more of said last named one or more computers is operated by an airline offering secure passenger flights.

64. The information system of claim 62 wherein said one or more of said last named one or more computers is operated by an airline offering secure baggage flights.

65. The information system of claim 60 wherein said data representing information for tracking baggage through the departure process can be entered into said third computer storage through a terminal at the departure airport.

66. A seat assignment process in a passenger departure process using an airline information system including multiple computers, one or more of said multiple computers located at a departure airport and one or more of said multiple computers located remotely from said departure airport, said information system further including multiple computer terminals for inputting data into any of a said multiple computers for tracking and controlling a secure air travel departure process for passengers and baggage being transported on secure flights, said secure flights including secure passenger flights and secure baggage flights, the process including the steps of:
checking to determine whether the passenger has previously secured a seat assignment on a secure passenger flight,
generating a boarding pass for said passenger responsive to an indication from said checking that indicates that said passenger has previously secured a seat assignment on said flight,
assigning said passenger's requested seat, responsive to an indication from said checking that indicates that said passenger has not previously secured a seat assignment on said flight, and
operating one of said multiple computer terminals to record within one of said multiple computers data representing the fact of said assigning and the identity of said seat that is assigned to said passenger.

67. A seat assignment process in a passenger departure process using an airline information system including multiple computers, one or more of said multiple computers located at a departure airport and one or more of said multiple computers located remotely from said departure airport, said information system further including multiple computer terminals for inputting data into any of a said multiple computers for tracking and controlling a secure air travel departure process for passengers and baggage being transported on secure flights, said secure flights including secure passenger flights and secure baggage flights, the process including the steps of:
determining a passenger's seat location preference prior to secure flight departures,
after said passenger arrives at departure airport, assigning said passenger a seat from available seats within said passenger's seat location preference, and
operating one of said multiple computer terminals to record said passenger's seat assignment in said airline information system.

68. The process of claim 67 followed by the step of operating one of said multiple data terminals to enter information into at least one of said multiple computers to generate a final list of passengers boarded on the secure passenger flight.

69. A passenger security check-in process using an airline information system including multiple computers, one or more of said multiple computers located at a departure airport and one or more of said multiple computers located remotely from said departure airport, said information system further including multiple computer terminals for inputting data into any of a said multiple computers for tracking and controlling a secure air travel departure process for passengers and baggage being transported on secure flights, said secure flights including secure passenger flights and secure baggage flights, the process including the steps of:
providing passenger security check-in areas for passengers boarding secure passenger flights,
determining whether a passenger requires legally allowed carry-on items,
providing, in response to a passenger requiring legally allowed carry-on items, elaborate security screening for said carry-on items,
allowing, in response to said passenger's legally allowed carry-on items successfully passing said elaborate security screening, said passenger to proceed to the boarding gate,
providing, in response to the elaborate screening of said passenger's legally allowed carry-on item's resulting in an indication of a security breach, information about said passenger to law enforcement personnel and operating one of said multiple computer terminals to record within at least one of said multiple computers information recording said security breach.

70. A baggage security, routing and departure process in an airline terminal wherein baggage is routed, is screened and is loaded on a secure baggage flight in which baggage and no passengers are transported, said airline terminal including data terminals for inputting and extracting from a computer system information for tracking said baggage and information for tracking passengers associated with said baggage, said process including the steps of:
collecting said baggage from a passenger at a collection location selected from the set of collection locations consisting of (a) curbside, (b) ticket counter, (c) baggage counter and (d) baggage pick-up remote from said terminal;
checking to determine whether said baggage is destined for said secure baggage flight;
if said baggage is so destined, passing said baggage through one or more baggage security screening devices taken from the collection of devices consisting of (a) X-ray detectors, (b) bomb detectors, (c) biohazard detectors, and (d) others required by the Federal Aviation Administration regulations;
checking said screening devices to determine whether any of said screening devices indicate a security breach in response to baggage passing through said any of said screening devices;
in response to none of said screening devices indicating a security breach, routing said baggage to the appropriate departing secure baggage flight; and
operating one of said data input terminals to record the results of said checking step in storage within said computer system.

71. The process of claim 70 wherein said baggage is loaded onto a secure baggage flight that is capable of accepting baggage from multiple airlines.

72. The process of claim 70 wherein, responsive to the step of passing said baggage through said one or more devices resulting in detecting an indication of a security breach, routing said baggage through additional baggage security screening devices, said additional screening devices providing additional security checks.

73. The process of claim 70 wherein in response to one of said additional security checks resulting in one of said additional baggage security screening devices indicating a security breach, operating one of said data terminals to extract from said computer system identification information of the passenger associated with said baggage and using said identification information to locate said passenger for interview or for additional security steps.

74. The process of claim 73 wherein if said interview or additional security steps indicate there is no security breach, loading said baggage on its secure baggage flight and boarding said passenger on the appropriate secure passenger flight.

75. The process of claim 73 wherein if said interview or additional steps indicate that there is a security breach, taking special screening or law enforcements steps.

76. The process of claim 75 further including the step of operating one of said data terminal to indicate that said special screening or law enforcement steps were taken in respect of said passenger.

77. An airline ticketing process for airlines offering secure flights and non-secure flights, said process using an airline information system including multiple computers, one or more of said multiple computers located at a departure airport and one or more of said multiple computers located remotely from said departure airport, said information system further including multiple computer terminals for inputting data into any of a said multiple computers for (1) tracking and controlling a secure air travel departure process for passengers and baggage being transported on secure flights, said secure flights including secure passenger flights and secure baggage flights, and (2) tracking and controlling an air travel departure process for non-secure flights, the process including the steps of:
checking to determine whether said passenger has selected a secure flight,
in response to said checking determining that said passenger has selected a secure flight, allowing said passenger to select a secure flight ticketing process selected from the collection of processes consisting of (1) on-line ticket purchase, (2) airline ticketing process wherein said passenger purchases said ticket by calling the airline, (3) ticket counter process wherein said ticket is purchased by said passenger at an airline ticket counter, (4) travel agent process wherein said ticket is purchased from a travel agent, and (5) frequent flyer award process wherein said ticket is purchased by redeeming frequent flyer miles,
allowing said passenger to purchase a ticket by said selected ticketing process, and
in response to said passenger further choosing to purchase the ticket, operating one of said multiple computer terminals to reserve said ticket in said airline information.

78. The process of claim 77 including the further step of said passenger choosing flight selections from the collection of choices consisting of (1) in-flight options, (2) special requests, (3) baggage carrier, (4) baggage source location and destination location, and (5) travel options, during said ticketing process.

79. The process of claim 77 further including the step of, in response to the step of checking to determine resulting in an indication that said passenger has selected a non-secure flight, allowing said passenger to purchase a non-secure flight ticket by said passenger selecting a secure flight ticketing process by using a ticket purchasing process selected from the collection of processes consisting of (1) on-line ticket purchase, (2) airline ticketing process wherein said passenger purchases said ticket by calling the airline, (3) ticket counter process wherein said ticket is purchased by said passenger at an airline ticket counter, (4) travel agent process wherein said ticket is purchased from a travel agent, and (5) frequent flyer award process wherein said ticket is purchased by redeeming frequent flyer miles, and operating one of said multiple computer terminals to enter data into storage in at least one of said multiple computers to issue said non-secure flight ticket to said passenger.

80. An electronic data signal for use in an airline information system, such system including
multiple computers including computer storage,
one or more of said multiple computers located at an airport and one or more of said multiple computers located remotely from said airport,
said information system further including multiple computer terminals for inputting data into any of a said multiple computers for tracking and controlling a secure air travel process for passengers and baggage being transported on secure flights, said secure flights including secure passenger flights and secure baggage flights,
said signal (a) embodied in storage in one or more of said multiple computers, and (b) including data fields containing information signals representing information taken from the collection of information representing

| | |
|---|---|
| (1) | passenger name, |
| (2) | ticket reservation information, |
| (3) | ticket purchase information, |
| (4) | ticket issuance information, |
| (5) | airline name, |
| (6) | secure passenger flight number(s), |
| (7) | secure baggage flight number(s), |
| (8) | flight stop-overs, |
| (9) | flight tracking information, |
| (10) | passenger biometric or other identity information, |
| (11) | boarding pass information, |
| (12) | seat assignment information, |
| (13) | flight manifest information, |
| (14) | baggage tracking information, |
| (15) | in-flight option selection information, |
| (16) | baggage delivery tracking information, |

wherein all or part of a replica of said electronic data signal is transmitted within said information system, accessed from storage, updated and returned to storage during tracking and controlling of said secure air travel process.

81. A process for tracking, routing and controlling passengers, baggage and flights in a secure air travel process from a departure airport to a destination airport for passengers and baggage being transported on secure flights,
said secure flights including secure passenger flights and secure baggage flights,
said process using an information system,
said information system including multiple computers,
one or more of said multiple computers located at an airport and one or more of said multiple computers located remotely from said airport,
said information system further including multiple computer data input and retrieval devices for inputting and retrieving data into and from any of a said multiple computers, said devices located at said departure airport or remote therefrom,
at least one of said data input and retrieval device being respectively located at at least one departure airport location selected from the collection of locations consisting of

| | |
|---|---|
| (1) | boarding gate locations, |
| (2) | curbside check-in locations, |
| (3) | ticket counter locations, |
| (4) | baggage loading locations, |
| (5) | baggage screening locations, |
| (6) | ticket reservation locations, |
| (7) | baggage counter locations, |
| (8) | law enforcement locations, |
| (9) | local passenger airline locations, |
| (10) | local baggage carrier airline locations, |
| (11) | passenger airline hub locations, |
| (12) | baggage airline hub locations, |
| (13) | ticket agent locations, and |
| (14) | passenger seat assignment, |

said process including the steps of:

| | |
|---|---|
| (a) | a passenger deciding to use said secure air travel and choosing to |
| | buy or reserve a ticket for said secure air travel, |
| (b) | using one of said data input and retrieved devices to connect to |
| | said information system for ticket reservation, |
| (c) | using said device of step (b) to (i) retrieve information from said |
| | information system (ii) updating information of said passenger |
| | indicating (1) that secure air travel has been chosen and (2) that |
| | ticketing has been reserved; and (3) baggage drop-off location has |
| | been selected, |
| (d) | said passenger arriving to the airport on the day of travel, and |
| | delivering said passenger's baggage as indicated in said baggage |
| | drop-off location, |
| (e) | providing said passenger with baggage tracking information |
| | retrieved from said information system, |
| (f) | transporting said baggage through baggage screening locations, |
| | baggage routing locations and baggage loading areas onto said |
| | secure baggage flight, |
| (g) | tracking said baggage through at least one of said locations in step |
| | (f) and updating said baggage tracking information in said |
| | information system, and |
| (h) | accessing said baggage tracking information in said information by |
| | systems operators at a passenger airline hub location or a baggage |
| | airline hub location or said destination airport to aid in routing said |
| | baggage to said destination airport. |

82. The process of claim 81 further including the steps of:

| | |
|---|---|
| (a) | processing said passenger through a security check-in process at |
| | the departure airport, |
| (b) | processing said passenger to said boarding process, |
| (c) | assigning a seat to said passenger including the step of updating |
| | said passenger seat assignment information using one of said data |
| | input and retrieval devices, |
| (d) | allowing said passenger to board said passenger flight, and |
| (e) | accessing said information through one of said data input and |
| | retrieval devices to generate a passenger manifest for said |
| | passenger flight. |

83. An airport terminal including (a) a passenger area for passengers transported on secure passenger flights and (b) a baggage area for baggage transported on secure baggage flights.

84. A method of operating an airline by offering secure passenger flights.

85. The method of claim 84 wherein the airline also offers secure baggage flights.

86. The method of claim 84 wherein said secure passenger flights include office services.

87. The method of claim 86 wherein said office services are offered free as an incentive for passengers to travel on said airline.

88. The method of operating an airline by providing secure passenger flights and also providing normal passenger flights.

89. The method of claim 88 wherein the airline provides passengers a method of electing whether to fly on normal flights or on secure flights.

90. A method of operating a baggage ground transport business by transporting baggage associated with airline passengers, said baggage transported to airlines that offer both secure passenger flights and secure baggage flights.

91. A method of operating a baggage ground transport business by transporting baggage associated with said airline passengers, said baggage transported to airlines that offer only secure baggage flights.

92. The method of claim 91 wherein the baggage is picked up from a passenger and delivered to (a) an airline terminal providing secure baggage flights or (b) an airline terminal providing normal flights.

93. A system of secure air travel comprising air terminal facilities providing for the transportation of passengers and baggage on secure flights.

94. The system of claim 93 that further includes air terminal facilities providing for the transportation of passengers and baggage on normal flights.

95. The system of claim 93 further including check-in facilities for checking in said baggage wherein said check-in facilities include at least one from the group consisting of (a) airport check-in counters, (b) baggage pick-up from a passenger's home, and (c) baggage pick-up from an origin departure location separate from the airport check-in counters and a passenger's home.

96. The system of claim 93 further including delivery facilities for delivering said transported baggage to at least one destination from the group consisting of (a) the destination airport, (b) the passenger's home, (c) the passenger's business destination, or (d) the passenger's pleasure destination.

97. The system of claim 93 wherein the secure flights and the normal flights are provided by the same airline.

98. The system of claim 93 wherein the secure baggage flights are provided by an airline that does not provide secure passenger flights.

99. An airline that provides secure baggage flights.

100. An airline that provides secure passenger flights.

101. The airline of claim 100 further providing on-board document management sites on said secure passenger flights.

102. The airline of claim 100 providing on-board data processing facilities.

103. An airline that provides secure baggage flights and further provides secure passenger flights.

104. An airline that provides (1) secure baggage flights, (2) secure passenger flights, and (3) normal passenger flights.

105. An information system including multiple computers, one or more of said multiple computers located at an airport and one or more of said multiple computers located remotely from said airport, said information system further including multiple computer data input and retrieval devices for inputting and retrieving data into any of a said multiple computers for tracking, routing and controlling passengers, baggage and flights for passengers and baggage being transported on secure flights, said secure flights including secure passenger flights and secure baggage flights.

106. The information system of claim 105 wherein some of said data input and retrieval device are respectively located at selected locations at an airport, said locations from the collection of locations consisting of (1) boarding gate locations, (2) curbside check-in locations, (3) ticket counter locations, (4) baggage loading locations, (5) baggage screening locations, (6) ticket reservation locations, (7) baggage counter locations, (8) law enforcement locations, (9) local passenger airline locations, (10) local baggage carrier airline locations, (11) passenger airline hub locations, and (12) baggage carrier airline hub locations.

107. The information system of claim 105 wherein said computers are selected from the group of computers consisting of (1) personal computers, (2) thin clients, (3) servers, (4) workstations, (5) handheld computers, (6) scanning devices with microcontrollers.

108. The information system of claim 105 including further including display devices, textual entry mechanisms, network connections, camera/scanner devices, fingerprint scanners, and other biometric input devices connected to them.

109. The information system of claim 105 wherein at least some of said computers include local memory and mass storage devices.

110. The information of claim 105 wherein said computers include software taken from the collection of devices consisting of windows based software, menu based software, graphical user interfaces and web browser interfaces.

111. The information system of claim 105 wherein said computers are connected with each other using networks.

112. The information system of claim 111 wherein at least one of said computers is operated by a passenger airline and at least one of said computers is operated by a baggage carrier airline.

113. The information system of claim 112 wherein said at least one computer operated by a passenger airline and said at least one computer operated by a baggage carrier airline are networked on the same network.

114. The information system of claim 112 wherein said at least one computer operated by a passenger airline and said at least one computer operated by a baggage carrier airline are networked on different networks.

115. The information system of claim 111 wherein said networks include at least one of the networks selected from the group of networks consisting of (1) local area networks, (2) metro area networks, (3) wide area networks, (4) wireless LANs, (5) Wireless data networks, and (6) internetworks.

116. The information system of claim 112 wherein electronic data records about passengers are stored locally and centrally between in said local memory and said mass storage devices in said at least one computer operated by a passenger airline and in said at least one computer operated by a baggage carrier airline using automated data sharing formats.

117. The information system of claim 116 wherein, in response to a request by a passenger to change destination or flight, said at least one computer operated by a passenger airline updates said passenger's electronic data record to change said destination to a new destination or to change said flight to a new flight.

118. The information system of claim 117 wherein, in response to said at least one computer operated by a passenger airline updating said electronic data record to change said destination or flight, said passenger airline updates said electronic data record to change said secure baggage flight to cause baggage associated with said passenger to be transported to said new destination or to arrive at a new time corresponding to the time of arrival of said new flight.

119. The information system of claim 117 wherein, in response to said at least one computer operated by a passenger airline updating said electronic data record to change said destination or flight, said baggage carrier airline updates said electronic data record to change said secure baggage flight to cause baggage associated with said passenger to be transported to said new destination or to arrive at a new time corresponding to the time of arrival of said new flight.

120. The Information system of claim 116 wherein said formats are selected from the group of data sharing formats consisting of EDI, XML, SGML, and other mark-up languages.

121. The method of operating an airline by providing secure baggage flights only.

122. The method of claim 121 wherein some of said secure baggage flights transport baggage associated with passengers on more than one passenger flight.
